(19) United States
(12) Patent Application Publication
(10) Pub. No.: US 2006/0123204 A1
(43) Pub. Date: Jun. 8, 2006

(54) Method and system for shared input/output adapter in logically partitioned data processing system

(75) Inventors: Deanna Lynn Quigg Brown, Phoenix, AZ (US); Vinit Jain, Austin, TX (US); Jeffrey Paul Messing, Austin, TX (US); Satya Prakash Sharma, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, ARMONK, NY (US)

(21) Appl. No.: 11/002,560

(22) Filed: Dec. 2, 2004

(51) Int. Cl. G06F 12/14

(52) U.S. Cl. 711/153

(57) ABSTRACT

A method for sharing resources in one or more data processing systems is disclosed. The method comprises a data processing system defining a plurality of logical partitions with respect to one or more processing units of one or more data processing systems, wherein a selected logical partition among the plurality of logical partitions includes a physical input/output adapter and each of the plurality of logical partitions includes a virtual input/output adapter. The data processing system then assigns each of one or more of the virtual input/output adapters a respective virtual network address and VLAN tag and shares resources by communicating data between a logical partition that is not the selected logical partition and an external network node via the virtual input/output adapter of the selected partition and the physical input/output adapter of the selected logical partition using packets containing VLAN tags and said virtual network address.

### CROSS-REFERENCE TO RELATED APPLICATION

The present application is related to the following co-pending U.S. patent application filed on even date herewith, and incorporated herein by reference in its entirety:

Ser. No. ______, filed on ______, entitled “METHOD, SYSTEM AND COMPUTER PROGRAM PRODUCT FOR TRANSITIONING NETWORK TRAFFIC BETWEEN LOGICAL PARTITIONS IN ONE OR MORE DATA PROCESSING SYSTEMS”.

### BACKGROUND OF THE INVENTION

1. Technical Field

The present invention relates in general to sharing resources in data processing systems and, in particular, to sharing an input/output adapter in a data processing system. Still more particularly, the present invention relates to a system, method and computer program product for a shared input/ouput adapter in a logically partitioned data processing system.

2. Description of the Related Art

Logical partitioning (LPAR) of a data processing system permits several concurrent instances of one or more operating systems on a single processor, thereby providing users with the ability to split a single physical data processing system into several independent logical data processing systems capable of running applications in multiple, independent environments simultaneously. For example, logical partitioning makes it possible for a user to run a single application using different sets of data on separate partitions, as if the application was running independently on separate physical systems.

Partitioning has evolved from a predominantly physical scheme, based on hardware boundaries, to one that allows for virtual and shared resources, with load balancing. The factors that have driven partitioning have persisted from the first partitioned mainframes to the modern server of today. Logical partitioning is achieved by distributing the resources of a single system to create multiple, independent logical systems within the same physical system. The resulting logical structure consists of a primary partition and one or more secondary partitions.

Problems with virtual or logical partitioning schemes have arisen from a shortage of physical input and output resources in a data processing server. With regard to any type of physical resource, data processing systems have proven unable to provide the physical resource connections necessary to provide access to peripheral equipment for all of the logical partitions requiring physical access.

Particularly with respect to network connections, the aforementioned problem of inadequate connectivity has frustrated designers of logically partitioned systems. While Virtual Ethernet technology is able to provide communication between LPARs on the same data processing system, network access outside a data processing system requires a physical adapter, such as a network adapter to interact with data processing systems on a remote LAN. In the prior art, communication for multiple LPARs is achieved by assigning a physical network adapter to every LPAR that requires access to the outside network. However, assigning a physical network adapter to every LPAR that requires access to the outside network has proven at best impractical and sometimes impossible due to cost considerations or slot limitations, especially for logical partitions that do not use large amounts of network traffic.

What is needed is a means to reduce the dependency on individual physical input/output adapters for each logical partition.

### SUMMARY OF THE INVENTION

A method for sharing resources in one or more data processing systems is disclosed. The method comprises a data processing system defining a plurality of logical partitions with respect to one or more processing units of one or more data processing systems, wherein a selected logical partition among the plurality of logical partitions includes a physical input/output adapter and each of the plurality of logical partitions includes a virtual input/output adapter. The data processing system then assigns each of one or more of the virtual input/output adapters a respective virtual network address and a VLAN tag and shares resources by communicating data between a logical partition that is not the selected logical partition and an external network node via the virtual input/output adapter of the selected partition and the physical input/output adapter of the selected logical partition using packets containing VLAN tags and the virtual network address.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 illustrates a block diagram of a data processing system in which a preferred embodiment of the system, method and computer program product for sharing an input/output adapter in a logically partitioned data processing system are implemented;

FIG. 2 illustrates virtual networking components in a logically partitioned processing unit in accordance with a preferred embodiment of the present invention;

FIG. 3 depicts an Ethernet adapter shared by multiple logical partitions of a processing unit in accordance with a preferred embodiment of the present invention;

FIG. 4 depicts a virtual input/output server on a processing unit in accordance with a preferred embodiment of the present invention;

FIG. 5 depicts a network embodiment for a processing units in accordance with a preferred embodiment of the present invention;

FIG. 6 is a high-level flowchart for handling a packet received from virtual Ethernet in accordance with a preferred embodiment of the present invention;

FIG. 7 is a high-level flowchart for handling a packet received from physical Ethernet in accordance with a preferred embodiment of the present invention; and

FIG. 8 is a high-level flowchart for sending a packet in a system, method and computer program product for a shared input/output adapter in accordance with a preferred embodiment of the present invention.

### DETAILED DESCRIPTION OF THE PREFERRED EMBODIMENT

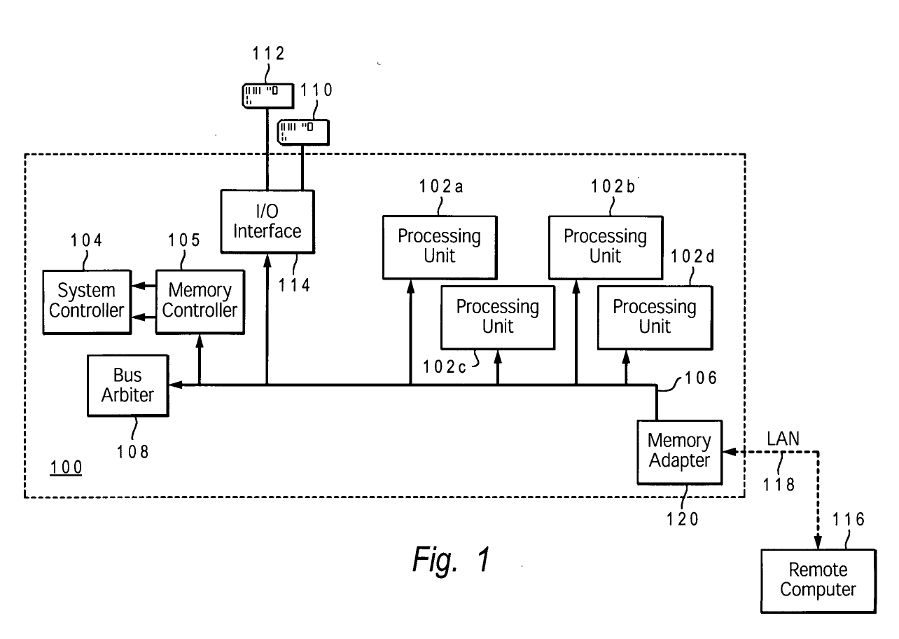

With reference now to figures and in particular with reference to FIG. 1, there is depicted a data processing system 100 that may be utilized to implement the method, system and computer program product of the present invention. For discussion purposes, the data processing system is described as having features common to a server computer. However, as used herein, the term “data processing system,” is intended to include any type of computing device or machine that is capable of receiving, storing and running a software product, including not only computer systems, but also devices such as communication devices (e.g., routers, switches, pagers, telephones, electronic books, electronic magazines and newspapers, etc.) and personal and home consumer devices (e.g., handheld computers, Web-enabled televisions, home automation systems, multimedia viewing systems, etc.).

FIG. 1 and the following discussion are intended to provide a brief, general description of an exemplary data processing system adapted to implement the present invention. While parts of the invention will be described in the general context of instructions residing on hardware within a server computer, those skilled in the art will recognize that the invention also may be implemented in a combination of program modules running in an operating system. Generally, program modules include routines, programs, components and data structures, which perform particular tasks or implement particular abstract data types. The invention may also be practiced in distributed computing environments where tasks are performed by remote processing devices that are linked through a communications network. In a distributed computing environment, program modules may be located in both local and remote memory storage devices.

Data processing system 100 includes one or more processing units 102a-102d, a system memory 104 coupled to a memory controller 105, and a system interconnect fabric 106 that couples memory controller 105 to processing unit(s) 102 and other components of data processing system 100. Commands on system interconnect fabric 106 are communicated to various system components under the control of bus arbiter 108.

Data processing system 100 further includes fixed storage media, such as a first hard disk drive 110 and a second hard disk drive 112. First hard disk drive 110 and second hard disk drive 112 are communicatively coupled to system interconnect fabric 106 by an input-output (I/O) interface 114. First hard disk drive 110 and second hard disk drive 112 provide nonvolatile storage for data processing system 100. Although the description of computer-readable media above refers to a hard disk, it should be appreciated by those skilled in the art that other types of media which are readable by a computer, such as a removable magnetic disks, CD-ROM disks, magnetic cassettes, flash memory cards, digital video disks, Bernoulli cartridges, and other later- developed hardware, may also be used in the exemplary computer operating environment.

Data processing system 100 may operate in a networked environment using logical connections to one or more remote computers, such as remote computer 116. Remote computer 116 may be a server, a router, a peer device or other common network node, and typically includes many or all of the elements described relative to data processing system 100. In a networked environment, program modules employed by to data processing system 100, or portions thereof, may be stored in a remote memory storage device, such as remote computer 116. The logical connections depicted in FIG. 1A include connections over a local area network (LAN) 118, but, in alternative embodiments, may include a wide area network (WAN).

When used in a LAN networking environment, data processing system 100 is connected to LAN 118 through an input/output interface, such as a network adapter 120. It will be appreciated that the network connections shown are exemplary and other means of establishing a communications link between the computers may be used.

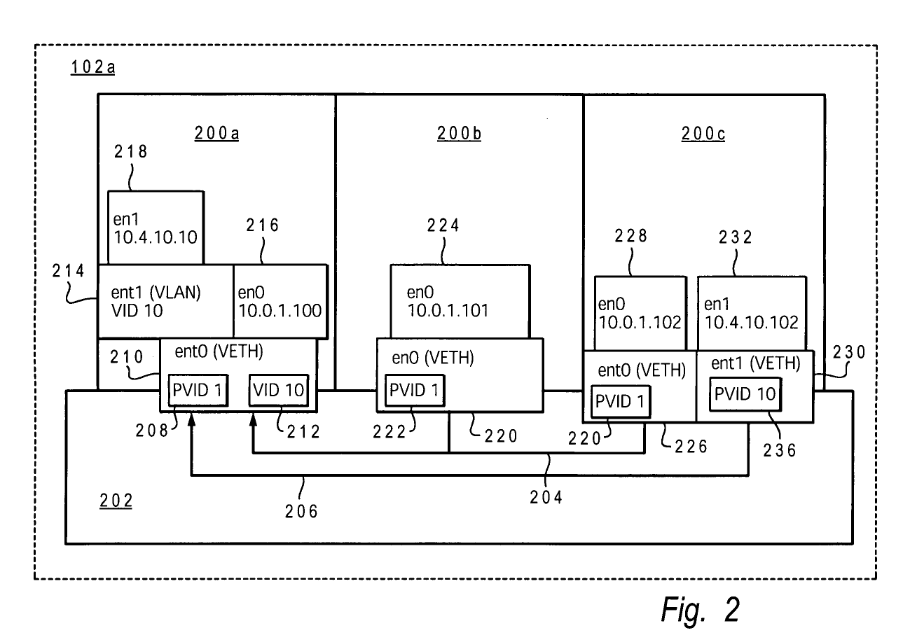

Turning now to FIG. 2, virtual networking components in a logically partitioned processing unit in accordance with a preferred embodiment of the present invention are depicted. Processing unit 102a runs three logical partitions 200a-200c and a management module 202 for managing interaction between and allocating resources between logical partitions 200a-200c. A first virtual LAN 204, implemented within management module 202, provides communicative interaction between first logical partition 200a, second logical partition 200b and third logical partition 200c. A second virtual LAN 206, also implemented within management module 202, provides communicative interaction between first logical partition 200a and third logical partition 200c.

Each of logical partitions 200a-200c (LPARs) is a division of a resources of processors 102a, supported by allocations of system memory 104 and storage resources on first hard disk drive 110 and second hard disk drive 112. Both creation of logical partitions 200a-200c and allocation of resources on processor 102a and data processing system 100 to logical partitions 200a-200c is controlled by management module 202. Each of logical partitions 200a-200c and its associated set of resources can be operated independently, as an independent computing process with its own operating system instance and applications. The number of logical partitions that can be created depends on the processor model of data processing system 100 and available resources. Typically, partitions are used for different purposes such as database operation or client/server operation or to separate test and production environments. Each partition can communicate with the other partitions as if the each other partition is in a separate machine through first virtual LAN 204 and second virtual LAN 206.

First virtual LAN 204 and second virtual LAN 206 are examples of virtual Ethernet technology, which enables IP-based communication between logical partitions on the same system. Virtual LAN (VLAN) technology is described by the IEEE 802.1Q standard, incorporated herein by reference. VLAN technology logically segments a physical network, such that layer 2 connectivity is restricted to members that belong to the same VLAN. As is further explained below, this separation is achieved by tagging Ethernet packets with VLAN membership information and then restricting delivery to members of a given VLAN.

VLAN membership information, contained in a VLAN tag, is referred to as VLAN ID (VID). Devices are configured as being members of VLAN designated by the VID for that device. Devices such as ent(0), as used in the present description define an instance of a representation of an adapter or a pseudo-adaptor in the functioning of an operating system. The default VID for a device is referred to as the Device VID (PVID). Virtual Ethernet adapter 208 is identified to other members of first virtual LAN 202 at device ent0, by means of PVID 1 210 and VID 10 212. First LPAR 200a also has a VLAN device 214 at device ent1 (VID 10), created over the base Virtual Ethernet adapter 210 at ent0, which is used to communicate with second virtual LAN 206. First LPAR 200a can also communicate with other hosts on the first virtual LAN 204 using the first virtual LAN 204 at device ent0, because management module 202 will strip the PVID tags before delivering packets on ent0 and add PVID tags to any packets that do not already have a tag. Additionally, first LPAR 200a has VLAN IP address 216 for Virtual Ethernet adapter 208 at device ent0 and a VLAN IP address 218 for VLAN device 214 at device ent1.

Second LPAR 200b also has a single Virtual Ethernet adapter 220 at device ent0, which was created with PVID 1 222 and no additional VIDs. Therefore, second LPAR 200b does not require any configuration of VLAN devices. Second LPAR 200b communicates over first VLAN 204 network by means of Virtual Ethernet adapter 220 at device ent0. Third LPAR 200c has a first Virtual Ethernet adapter 226 at device ent0 with a VLAN IP address 230 and a second Virtual Ethernet adapter 228 at device ent1 with a VLAN IP address 232, created with PVID 1 234 and PVID 10 236, respectively. Neither second LPAR 200b nor third LPAR 200c has any additional VIDs defined. As a result of its configuration, third LPAR 200c can communicate over both first virtual LAN 204 and second virtual LAN 206 using first Virtual Ethernet adapter 226 at device ent0 with a VLAN IP address 230 and a second Virtual Ethernet adapter 228 at device ent1 with a VLAN IP address 232, respectively.

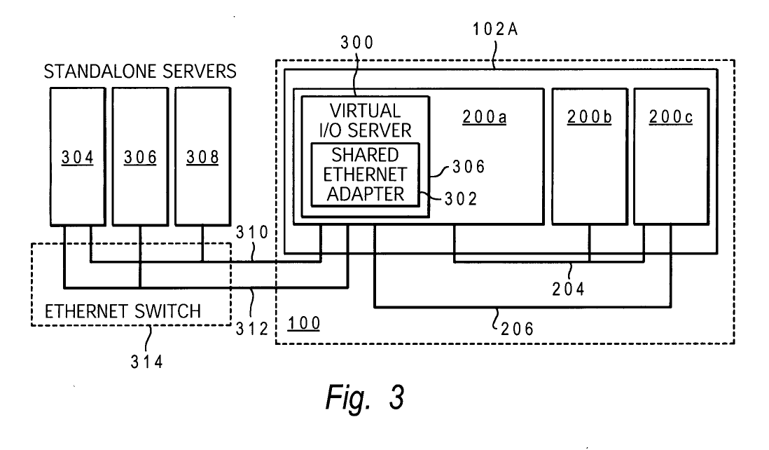

With reference now to FIG. 3, an Ethernet adapter shared by multiple logical partitions of a processing unit in accordance with a preferred embodiment of the present invention is illustrated. Data processing system 100, containing processing unit 102a, which is logically partitioned into logical partitions 200a-200c (LPARs), also runs virtual I/O server 300, which contains a shared Ethernet adapter 302, for interacting with network interface 120 to allow first LPAR 200a, second LPAR 200b, and third LPAR 200c to communicate among themselves and with first standalone data processing system 304, second standalone data processing system 306, and third standalone data processing system 308 over a combination of first virtual LAN 204, second virtual LAN 206, first remote LAN 310, and second remote LAN 312 through Ethernet switch 314. First LPAR 200a provides connectivity between virtual I/O server 300, and is called a hosting partition.

While Virtual Ethernet technology is able to provide communication between LPARs 200a-200c on the same data processing system 100, network access outside data processing system 100 requires a physical adapter, such as network adapter 120 to interact with remote LAN 310, and second remote LAN 312. In the prior art, interaction with remote LAN 310, and second remote LAN 312 was achieved by assigning a physical network adapter 120 to every LPAR that requires access to an outside network, such as LAN 118. In the present invention, a single physical network adapter 120 is shared among multiple LPARs 200a-200c.

In the present invention, a special module within first partition 200a, called Virtual I/O server 300 provides an encapsulated device partition that provides services such as network, disk, tape and other access to LPARs 200a-200c without requiring each partition to own an individual device such as network adapter 120. The network access component of Virtual I/O server 300 is called the Shared Ethernet Adapter (SEA) 302. While the present invention is explained with reference to SEA 302, for use with network adapter 120, the present invention applies equally to any peripheral adapter or other device, such as I/O interface 114.

SEA 302 serves as a bridge between a physical network adapter 120 or an aggregation of physical adapters and one or more of first virtual LAN 204 and second virtual LAN 206 on the Virtual I/O server 300. SEA 302 enables LPARs 200a-200c on first virtual LAN 204 and second virtual LAN 206 to share access to physical Ethernet switch 314 through network adapter 120 and communicate with first standalone data processing system 304, second standalone data processing system 306, and third standalone data processing system 308 (or LPARs running on first standalone data processing system 304, second standalone data processing system 306, and third standalone data processing system 308). SEA 302 provides this access by connecting, through management module 202, first virtual LAN 204 and second virtual LAN 206 with remote LAN 310 and second remote LAN 312, allowing machines and partitions connected to these LANs to operate seamlessly as member of the same VLAN. Shared Ethernet adapter 302 enables LPARs 200a-200c on processing unit 102a of data processing system 100 to share an IP subnet with first standalone data processing system 304, second standalone data processing system 306, and third standalone data processing system 308 and LPARs on processing units 102b-d to allow for a more flexible network.

The SEA 302 processes packets at layer 2. Because the SEA 302 processes packets at layer 2, the original MAC address and VLAN tags of a packet remain visible to first standalone data processing system 304, second standalone data processing system 306, and third standalone data processing system 308 on the Ethernet switch 314.

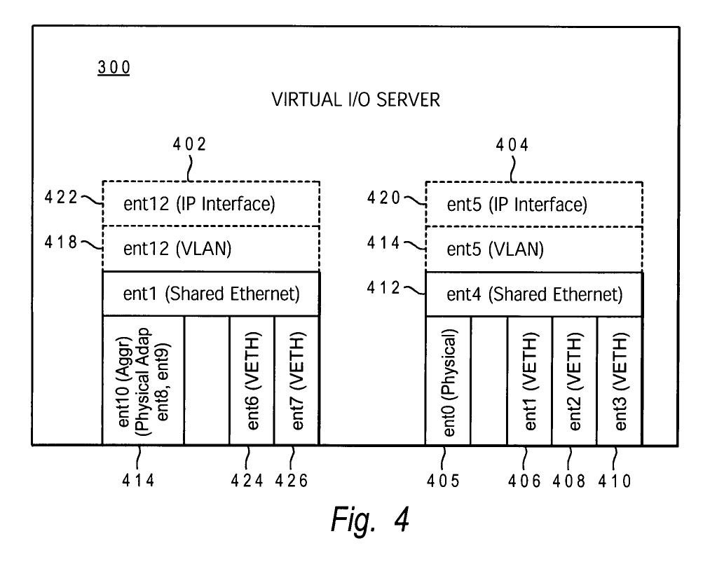

Turning now to FIG. 4, depicts a virtual input/output server on a processing unit in accordance with a preferred embodiment of the present invention is depicted. As depicted above, Virtual I/O server 300 provides partition of network adapter 120 to support a first SEA 402 and a second SEA 404. Second SEA 404 at device ent4 is configured to interact with a physical adapter 120 (through a driver 405 for physical adapter 120 at device ent0), first virtual trunk adapter 406 (at device ent1), second virtual trunk adapter 408 (at device ent2), and third virtual trunk adapter 410 (at device ent3). Second virtual trunk adapter 408 (at device ent2) represents first virtual LAN 204 and third trunk adapter 410 (at device ent3) represents second virtual LAN 206.

First virtual LAN 204 and second virtual LAN 206 are extended to the external network through driver 405 for physical adapter 120 at device ent0. Additionally, one can further create additional VLAN devices using SEA 412 at device ent4 and use these additional VLAN devices to enable the Virtual I/O server 300 to communicate with LPARs 200a-200c on the virtual LAN and the standalone servers 304-308 on the physical LAN. One VLAN device is required for each network with which the Virtual I/O server 300 is configured to communicate. The SEA 412 at device ent4 can also be used without the VLAN device to communicate with other LPARs on the VLAN network represented by the PVID of the SEA. As depicted in FIG. 4, first SEA 402 at device ent1 is configured in the same Virtual I/O server partition as second SEA 404. First SEA 402 uses a link aggregation 414 at device ent10, consisting of two physical adapters at devices ent8 and ent9, instead of a single physical adapter. These physical adapters are therefore connected to link-aggregated devices of an Ethernet switch 314.

Link Aggregation (also known as EtherChannel) is a network device aggregation technology that allow several Ethernet adapters to be aggregated together to form a single pseudo-Ethernet device. For example, ent0 and ent1 can be aggregated to ent3; interface en3 would then be configured with an IP address. The system considers these aggregated adapters as one adapter. Therefore, IP is configured over them as over any Ethernet adapter. In addition, all adapters in the Link Aggregation are given the same hardware (MAC) address, so they are treated by remote systems as if they were one adapter. The main benefit of Link Aggregation is that the aggregation can employ the network bandwidth of all associated adapters in a single network presence. If an adapter fails, the packets are automatically sent on the next available adapter without disruption to existing user connections. The failing adapter is automatically returned to service on the Link Aggregation when the failing adapter recovers.

First SEA 402 and second SEA 404, each of which were referred to as SEA 302 above, can optionally be configured with IP addresses to provide network connectivity to a Virtual I/O server without any additional physical resources. In FIG. 4, this optional configuration is shown as VLAN device 416 at device ent5, VLAN device 418 at device ent12, IP interface 420 at device ent5, and IP interface 422 at device ent12. First SEA 402 also accommodates a first virtual trunk interface 424 at device ent6 and a second virtual trunk interface 426 at device ent7. The physical adapter 120 and virtual adapters 406-408 that are part of a Shared Ethernet configuration are for exclusive use of the SEA 302 and therefore can not be configured with IP addresses. The SEA 302 itself can be configured with an IP address to provide network connectivity to the Virtual I/O server 300. The configuration of an IP address for the SEA is optional as it is not required for the device to perform a bridge function at layer 2.

First virtual trunk adapter 406 (at device ent1), second virtual trunk adapter 408 (at device ent2), and third virtual trunk adapter 410 (at device ent3), the virtual Ethernet adapters that are used to configure First SEA 402, are required to have a trunk setting enabled from the management module 202. The trunk setting causes first virtual trunk adapter 406 (at device ent1), second virtual trunk adapter 408 (at device ent2), and third virtual trunk adapter 410 (at device ent3) to operate in a special mode, in which they can deliver and accept external packets from virtual I/O server 300 and send to Ethernet switch 314. The trunk setting described above should only be used for the Virtual Ethernet adapters that are part of a SEA setup 302 in the Virtual I/O server 300. A Virtual Ethernet adapter 302 with the trunk setting becomes the Virtual Ethernet trunk adapter for all the VLANs that it belongs to. Since there can only be one Virtual Ethernet adapter with the trunk setting per VLAN, any overlap of the VLAN memberships should be avoided between the Virtual Ethernet trunk adapters.

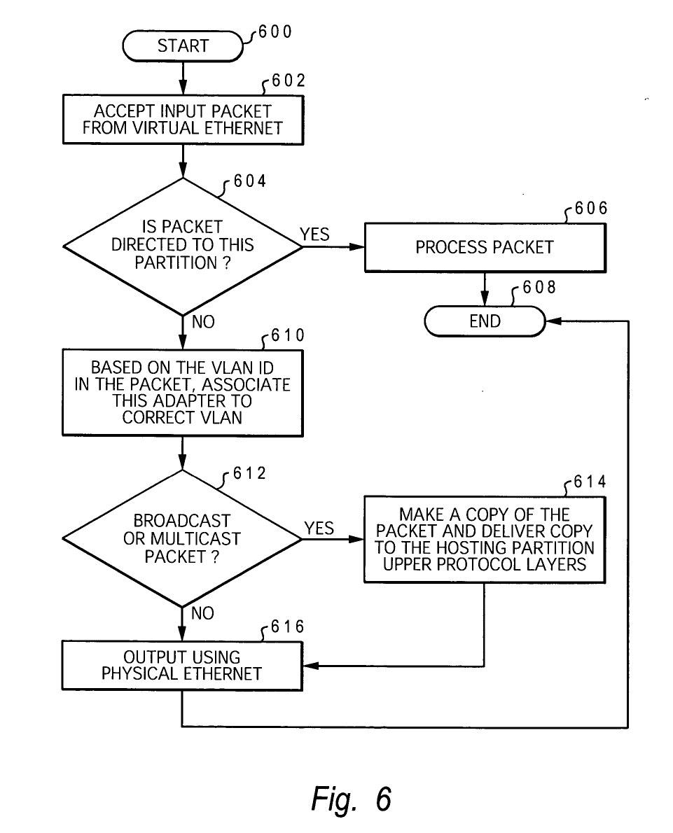

The present invention supports inter-LPAR communication using virtual networking. Management module 202 on processing unit 102a systems supports Virtual Ethernet adapters that are connected to an IEEE 802.1Q (VLAN)-style Virtual Ethernet switch. Using this switch function, LPARs 200a-200c can communicate with each other by using Virtual Ethernet adapters 406-410 and assigning VIDs (VLAN ID) that enable them to share a common logical network. Virtual Ethernet adapters 406-410 are created and the VID assignments are done using the management module 202. As is explained below with respect to FIG. 6, management module 202 transmits packets by copying the packet directly from the memory of the sender partition to the receive buffers of the receiver partition without any intermediate buffering of the packet.

The number of Virtual Ethernet adapters per LPAR varies by operating system. Management module 202 generates a locally administered Ethernet MAC address for the Virtual Ethernet adapters so that these addresses do not conflict with physical Ethernet adapter MAC addresses. To ensure uniqueness among the Virtual Ethernet adapters, the address generation is based, for example, on the system serial number, LPAR ID and adapter ID.

For VLAN-unaware operating systems, each Virtual Ethernet adapter 406-408 should be created with only a PVID (no additional VID values), and the management module 202 will ensure that packets have their VLAN tags removed before delivering to that LPAR. In VLAN- aware systems, one can assign additional VID values besides the PVID, and the management module 202 will only strip the tags of any packets which arrive with the PVID tag. Since the number of Virtual Ethernet adapters supported per LPAR is quite large, one can have multiple Virtual Ethernet adapters with each adapter being used to access a single network and therefore assigning only PVID and avoiding the additional VID assignments. This also has the advantage that no additional VLAN configuration is required for the operating system using these Virtual Ethernet adapters.

After creating Virtual Ethernet adapters for an LPAR using the management module 202, the operating system in the partition they belong to will recognize them as a Virtual Ethernet devices. These adapters appear as Ethernet adapter devices 406-410 (entX) of type Virtual Ethernet. Similar to driver 405 for physical Ethernet adapter 120, a VLAN device can be configured over a Virtual Ethernet adapter. A Virtual Ethernet device that only has a PVID assigned through the management module 202 does not require VLAN device configuration as the management module 202 will strip the PVID VLAN tag. A VLAN device is required for every additional VLAN ID that was assigned the Virtual Ethernet adapter when it was created using the management module 202 so that the VLAN tags are processed by the VLAN device.

The Virtual Ethernet adapters can be used for both IPv4 and IPv6 communication and can transmit packets with a size up to 65408 bytes. Therefore, the maximum MTU for the corresponding interface can be up to 65394 bytes (65390 with VLAN tagging). Because SEA 302 can only forward packets of size up to the MTU of the physical Ethernet adapters, a lower MTU or PMTU discovery should be used when the network is being extended using the Shared Ethernet. All applications designed to communicate using IP over Ethernet should be able to communicate using the Virtual Ethernet adapters.

SEA 302 is configured in the partition of Virtual I/O server 300, namely first LPAR 200a. Setup of SEA 302 requires one or more physical Ethernet adapters, such as network adapter 120 assigned to the host I/O partition, such as first LPAR 200a, and one or more Virtual Ethernet adapters 406-410 with the trunk property defined using the management module 202. The physical side of SEA 302 is either a single driver 405 for Ethernet adapter 120 or a link aggregation of physical adapters 414. Link aggregation 414 can also include an additional Ethernet adapter as a backup in case of failures on the network. SEA 302 setup requires the administrator to specify a default trunk adapter on the virtual side (PVID adapter) that will be used to bridge any untagged packets received from the physical side and also specify the PVID of the default trunk adapter. In the preferred embodiment, a single SEA 302 setup can have up to 16 Virtual Ethernet trunk adapters and each Virtual Ethernet trunk adapter can support up to 20 VLAN networks. The number of Shared Ethernet Adapters that can be set up in a Virtual I/O server partition is limited only by the resource availability as there are no configuration limits.

SEA 302 directs packets based on the VLAN ID tags, and obtains information necessary to route packets based on observing the packets originating from the Virtual Ethernet adapters 406-408. Most packets, including broadcast (e.g., ARP) or multicast (e.g., NDP) packets, which pass through the Shared Ethernet setup, are not modified. These packets retain their original MAC header and VLAN tag information. When the maximum transmission unit (MTU) size of the physical and virtual side do not match SEA 302 may receive packets that cannot be forwarded because of MTU limitations. Oversized packets are handled by SEA 302 processing the packets at the IP layer by either IP fragmentation or reflecting Internet Control Message Protocol (ICMP) errors (packet too large) to the source, based on the IP flags in the packet. In the case of IPv6, the packets ICMP errors are sent back to the source as IPv6 allows fragmentation only at the source host. These ICMP errors help the source host discover the Path Maximum Transfer Unit (PMTU) and therefore handle future packets appropriately.

Host partitions, such as first LPAR 200a, that are VLAN-aware can insert and remove their own tags and can be members of more than one VLAN. These host partitions are typically attached to devices, such as processing unit 102a, that do not remove the tags before delivering the packets to the host partition, but will insert the PVID tag when an untagged packet enters the device. A device will only allow packets that are untagged or tagged with the tag of one of the VLANs to which the device belongs. These VLAN rules are in addition to the regular MAC address-based forwarding rules followed by a switch. Therefore, a packet with a broadcast or multicast destination MAC will also be delivered to member devices that belong to the VLAN that is identified by the tags in the packet. This mechanism ensures the logical separation of physical networks based on membership in a VLAN.

The VID can be added to an Ethernet packet either by a VLAN-aware host, such as first LPAR 200a of FIG. 2, or, in the case of VLAN-unaware hosts, by a switch 314. Therefore, devices on an Ethernet switch 314 have to be configured with information indicating whether the host connected is VLAN-aware or unaware. For VLAN-unaware hosts, a device is set up as untagged, and the switch will tag all packets entering through that device with the Device VLAN ID (PVID). It will also untag all packets exiting that device before delivery to the VLAN unaware host. A device used to connect VLAN-unaware hosts is called an untagged device and can only be a member of a single VLAN identified by its PVID.

As VLAN ensures logical separation at layer 2, it is not possible to have an IP network 118 that spans multiple VLANs (different VIDs). A router or switch 314 that belongs to both VLAN segments and forwards packets between them is required to communicate between hosts on different VLAN segments. However a VLAN can extend across multiple switches 314 by ensuring that the VIDs remain the same and the trunk devices are configured with the appropriate VIDs. Typically, a VLAN-aware switch will have a default VLAN (1) defined. The default setting for all its devices is such that they belong to the default VLAN and therefore have a PVID I and assume that all hosts connecting will be VLAN unaware (untagged). This setting makes such a switch equivalent to a simple Ethernet switch that does not support VLAN.

In the preferred embodiment, VLAN tagging and untagging is configured by creating a VLAN device (e.g. ent1) over a physical (or virtual) Ethernet device (e.g. ent0) and assigning it a VLAN tag ID. An IP address is then assigned on the resulting interface (e.g. en1) associated with the VLAN device. The present invention supports multiple VLAN devices over a single Ethernet device each with its own VID. Each of these VLAN devices (ent) is an endpoint to access the logically separated physical Ethernet network and the interfaces (en) associated with them are configured with IP addresses belonging to different networks.

In general, configuration is simpler when devices are untagged and only the PVID is configured, because the attached hosts do not have to be VLAN-aware and do not require any VLAN configuration. However, this scenario has the limitation that a host can access only a single network using a physical adapter. Therefore untagged devices with PVID only are preferred when accessing a single network per Ethernet adapter and additional VIDs should be used only when multiple networks are being accessed through a single Ethernet adapter.

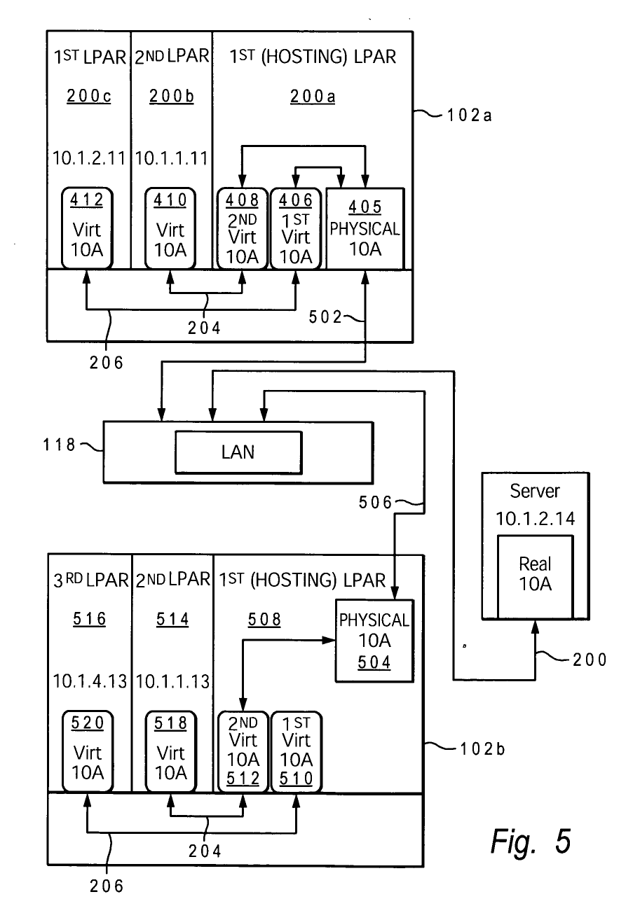

With reference now to FIG. 5, a network embodiment for a processing units in accordance with a preferred embodiment of the present invention is depicted. The network shown in FIG. 5 includes a first processing unit 102a, a second processing unit 102b, remote computer 116 and a LAN 118 over which processing unit 102a, processing unit 102b, and remote computer 116 are communicatively coupled. Processing unit 102a contains three logical partitions. First logical partition 200a serves as a hosting logical partition, second logical partition 200b and third logical partition 200c are also present on processing unit 102a. First logical partition 200a hosts a driver 405 for physical internet adapter 120 as well as a first virtual internet adapters 406 and a second virtual internet adapter 408. First virtual internet adapter 406 connects to third logical partition 200c through virtual internet input/output adapter 412 over second virtual LAN 206. Second virtual internet adapter 408 connects to second logical partition 200b through virtual internet adapter 410 over first virtual LAN 204. Additionally, within first logical partition 200a on processing unit 102a driver physical network adapter 120 connects to first virtual input/output adapter 406 and second input/output adapter 408. A LAN connection 502 connects processing unit 102a to LAN 118 and provides connectivity to second processing unit 102b.

Within second processing unit 102b, a driver for a physical Ethernet adapter 504 provides connectivity to LAN 118 via a LAN connection 506. Processing unit 102b is similarly divided into three logical partitions. First logical partition 508 serves as a hosting partition supporting a physical input/output adapter 504, a first virtual adapter 510 and a second virtual adapter 512. Second processing unit 102b also supports a second logical partition 514 and a third logical partition 516. Second logical partition 516 supports a virtual input/output adapter 518, and third logical partition 516 supports a virtual input/output adapter 520. As in processing unit 102a, first virtual LAN 204 connects second virtual input/output adapter 512 and virtual input/output adapter 518. Likewise, first virtual input adapter 510 is connected to virtual input adapter 520 over second virtual LAN 206, thus demonstrating the ability of virtual LANs to be supported across multiple machines. Remote computer 116 also connects to second virtual LAN 206 across LAN 118. As is illustrated in the embodiment depicted in FIG. 5, an IP subnet extends over multiple physical systems.

Turning now to FIG. 6, a high-level flowchart for handling a packet received from virtual Ethernet in accordance with a preferred embodiment of the present invention is depicted. The process starts at step 600. The process then moves to step 602, which illustrates SEA 302 accepting an input packet from a virtual Ethernet device. The process then moves to step 604. At step 604, SEA 302 on virtual I/O server 300 determines whether the received packet is intended for the partition containing virtual I/O server 300. If the received packet is intended for the partition containing virtual I/O server 300, then the process next proceeds to step 606. Step 606 depicts the logical partition, such as first logical partition 200a, processing the packet received by virtual I/O server 300. The process then ends at step 608.

If, at step 604, SEA 302 on virtual I/O server 300 determines that the received packet is not intended for the hosting partition, then the process next moves to step 610. At step 610, SEA 302 on virtual I/O server 300 associates, based on the VLAN ID in the received packet, a sending adapter to a correct VLAN. The process then moves to step 612. At step 612, the SEA 302 determines whether the packet under consideration, which was received from a virtual Ethernet adapter, is intended for broadcast or multicast.

If, at step 612, a determination is made that the received packet is intended for broadcast or multicast, then the process proceeds to step 614, which depicts SEA 302 on virtual I/O server 300 making a copy of the packet and delivering a copy to the upper protocol layers of the hosting partition. The process then moves to step 616, which depicts SEA 302 on virtual I/O server 300 performing output of the received packet to the physical network adapter 120 for transmission over LAN 118 to a remote computer 116. The process then ends at step 608.

If, at step 612, SEA 302 on virtual I/O server 300 determines that the packet is not broadcast or multicast packet, then the process proceeds directly to step 616, as described above.

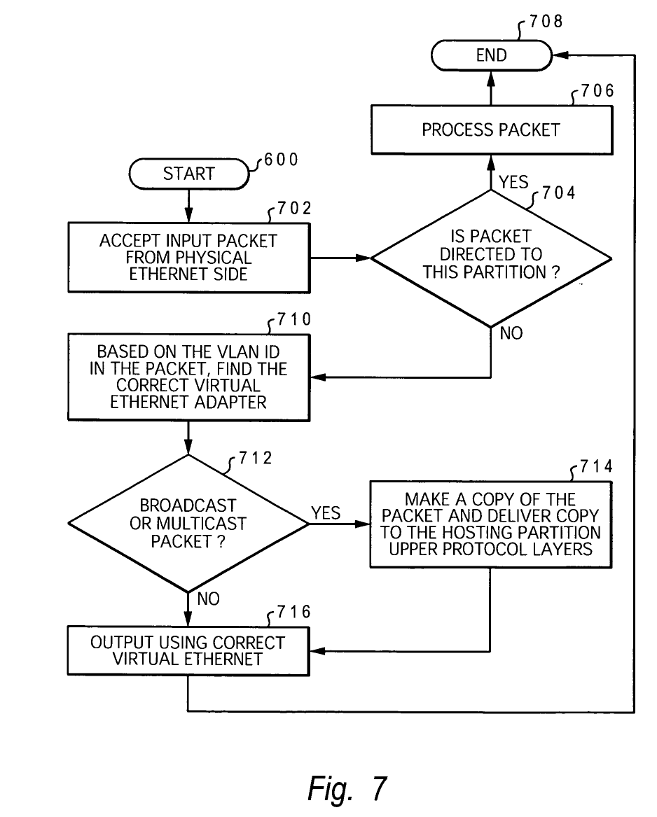

With reference now to FIG. 7, a high-level flowchart for handling a packet received from physical Ethernet in accordance with a preferred embodiment of the present invention is illustrated. The process starts at step 700. The process then moves to step 702, which illustrates SEA 302 accepting an input packet from a physical Ethernet device. The process then moves to step 704. At step 704, SEA 302 on virtual I/O server 300 determines whether the received packet is intended for the partition containing virtual I/O server 300. If the received packet is intended for the partition containing virtual I/O server 300, then the process next proceeds to step 704. Step 704 depicts the logical partition, such as first logical partition 200a, processing the packet received by virtual I/O server 300. The process then ends at step 708.

If at step 704, SEA 302 on virtual I/O server 300 determines that the received packet is not intended for the hosting partition, then the process next moves to step 710. At step 710, SEA 302 on virtual I/O server 300 determines, based on the VLAN ID in the packet, a correct VLAN adapter. The process then moves to step 712. At step 712, the SEA 302 determines whether the packet under consideration, which was received from a physical Ethernet adapter, is intended for broadcast or multicast.

If, at step 712, a determination is made that the received packet is intended for broadcast or multicast, then the process proceeds to step 714, which depicts SEA 302 on virtual I/O server 300 making a copy of the packet and delivering a copy to the upper protocol layers of the hosting partition. The process then moves to step 716, which depicts SEA 302 on virtual I/O server 300 performing output of the received packet to a virtual Ethernet adapter for transmission over LAN 118 to a remote computer 116. The process then moves to step 708, where it ends.

If at step 712, SEA 302 on virtual I/O server 300 determines that the packet is not broadcast or multicast packet, then the process proceeds directly to step 716, as described above.

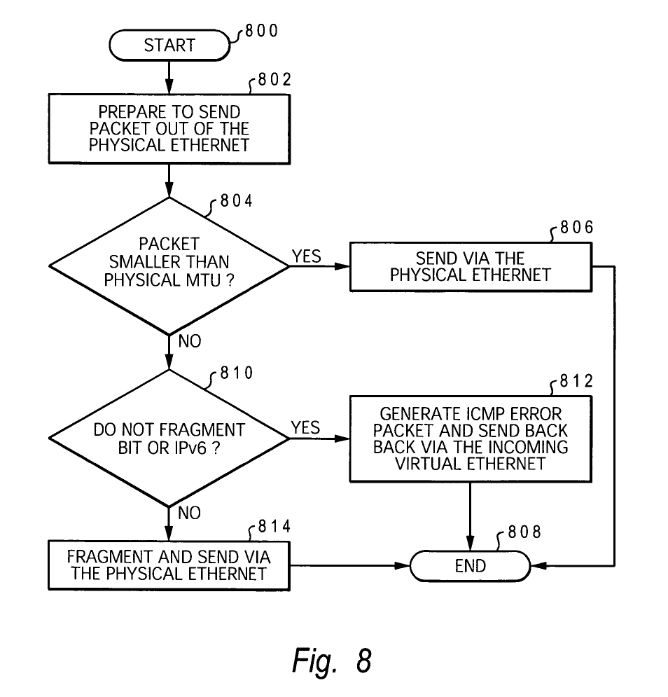

Turning now to FIG. 8, is a high-level flowchart for sending a packet in a system, method and computer program product for a shared input/output adapter in accordance with a preferred embodiment of the present invention. The process starts at step 800, which depicts activation of a routine within SEA 302 on virtual I/O server 300. The process then moves to step 802, which depicts SEA 302 on virtual I/O server 300 preparing to send a packet to physical LAN 118. The process next proceeds to step 804, which depicts SEA 302 on virtual I/O server 300 determining whether the packet prepared to be sent in step 802 is smaller than the physical MTU of network interface 120.

If, in step 804, SEA 302 determines that the packet prepared for transmission in step 802 is smaller than the physical MTU of the physical network adapter 120, then the process proceeds to step 806. At step 806, SEA 302 on virtual I/O server 300 sends the packet to remote computer 116 over the physical Ethernet embodied by LAN 118 through network interface 120. The process thereafter ends at step 808.

If, in step 804, SEA 302 on virtual I/O server 300 determines that the packet is not smaller than the physical MTU of network interface 120, then the process next proceeds to step 810. Step 810 depicts SEA 302 on virtual I/O server 300 determining whether a “do not fragment” bit has been set or IPv6 is in use on data processing system 100. If a “do not fragment bit” has been set or IPv6 is in use, then the process moves to step 812. At step 812, SEA 302 on virtual I/O server 300 generates an ICMP error packet and sends the ICMP error packet back to the sending virtual Ethernet adapter via virtual Ethernet. The process then ends at step 806.

If at step 810, it is determined that IPv6 is not in use on data processing system 100, and that no “do not fragment” bit has been set, then the process proceeds to step 814, which depicts fragmenting the packet and sending the packet via the physical Ethernet through network adapter 120 over LAN 118 to remote computer 116. The process next ends at step 808.

In the preferred embodiment, SEA (SEA) technology enables the logical partitions to communicate with other systems outside the hardware unit without assigning physical Ethernet slots to the logical partitions.

The SEA in the present invention and its associated VLAN tag-based routing, offer great flexibility in configuration scenarios. Workloads can be easily consolidated with more control over resource allocation. Network availability can also be improved for more systems with fewer resources using a combination of Virtual Ethernet, Shared Ethernet and link aggregation in the Virtual I/O server. When there are not enough physical slots to allocate a physical network adapter to each LPAR network access using Virtual Ethernet and a Virtual I/O server is a preferable to IP forwarding as it does not complicate the IP network topology.

While the invention has been particularly shown and described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for sharing resources in one or more data processing systems, said method comprising:
defining a plurality of logical partitions with respect to one or more processing units of one or more data processing system, wherein a selected logical partition among said plurality of logical partitions includes a physical input/output adapter and each of said plurality of logical partitions includes a virtual input/output adapter;
assigning each of one or more of said virtual input/output adapters a respective virtual network address; and
sharing resources by communicating data between a logical partition that is not the selected logical partition and an external network node via said virtual input/output adapter of said selected partition and said physical input/output adapter of said selected logical partition using packets containing VLAN tags and said virtual network address.

2. The method of claim 1, wherein said assigning step further comprises assigning each of one or more of said virtual input/output adapters a respective layer 2 address.

3. The method of claim 1, wherein said sharing step further comprises:
accepting an output packet at said virtual input/output adapter of said selected logical partition; and
transmitting said output packet to a physical network through said physical input/output adapter of said selected logical partition.

4. The method of claim 1, wherein said assigning step further comprises:
assigning virtual network addresses within a virtual local area network to a plurality of logical partitions residing on multiple processing units within multiple data processing systems.

5. The method of claim 1, wherein said sharing step further comprises:
supporting multiple virtual local area networks with a single physical input/output adapter.

6. The method of claim 1, wherein said assigning step further comprises:
assigning one or more virtual network addresses within a virtual local area network to a plurality of logical partitions residing on multiple processing units on a single data processing system.

7. The method of claim 1, wherein said sharing step further comprises:
accepting an input packet at said physical input/output adapter from a physical network; and
delivering said input packet to one or more of said plurality of virtual input/output adapters on a virtual local area network using a virtual network address in said input packet.

8. A system for sharing resources in one or more data processing systems, said system comprising:
means for defining a plurality of logical partitions with respect to one or more processing units of one or more data processing system, wherein a selected logical partition among said plurality of logical partitions includes a physical input/output adapter and each of said plurality of logical partitions includes a virtual input/output adapter;
means for assigning each of one or more of said virtual input/output adapters a respective virtual network address; and
means for sharing resources by communicating data between a logical partition that is not the selected logical partition and an external network node via said virtual input/output adapter of said selected partition and said physical input/output adapter of said selected logical partition using packets containing VLAN tags and said virtual network address.

9. The system of claim 8, wherein said assigning means further comprises means for assigning each of one or more of said virtual input/output adapters a respective layer 2 address.

10. The system of claim 8, wherein said sharing means further comprises:
means for accepting an output packet at said virtual input/output adapter of said selected logical partition; and
means for transmitting said output packet to a physical network through said physical input/output adapter of said selected logical partition.

11. The system of claim 8, wherein said assigning means further comprises:
means for assigning virtual network addresses within a virtual local area network to a plurality of logical partitions residing on multiple processing units within multiple data processing systems.

12. The system of claim 8, wherein said sharing means further comprises:
means for supporting multiple virtual local area networks with a single physical input/output adapter.

13. The system of claim 8 wherein said assigning means further comprises:
means for assigning one or more virtual network addresses within a virtual local area network to a plurality of logical partitions residing on multiple processing units on a single data processing system.

14. The system of claim 8, wherein said sharing means further comprises:
means for accepting an input packet at said physical input/output adapter from a physical network; and
means for delivering said input packet to one or more of said plurality of virtual input/output adapters on a virtual local area network using a virtual network address in said input packet.

15. A computer program product in a computer-readable medium for sharing resources in one or more data processing systems, said computer program product comprising:
a computer-readable medium;
instructions on the computer-readable medium for defining a plurality of logical partitions with respect to one or more processing units of one or more data processing system, wherein a selected logical partition among said plurality of logical partitions includes a physical input/output adapter and each of said plurality of logical partitions includes a virtual input/output adapter;
instructions on the computer-readable medium for assigning each of one or more of said virtual input/output adapters a respective virtual network address; and
instructions on the computer-readable medium for sharing resources by communicating data between a logical partition that is not the selected logical partition and an external network node via said virtual input/output adapter of said selected partition and said physical input/output adapter of said selected logical partition using packets containing VLAN tags and said virtual network address.

16. The computer program product of claim 15, wherein said assigning instructions further comprise instructions on the computer-readable medium for assigning each of one or more of said virtual input/output adapters a respective layer 2 address.

17. The computer program product of claim 15, wherein said sharing instructions further comprise:
instructions on the computer-readable medium for accepting an output packet at said virtual input/output adapter of said selected logical partition; and
instructions on the computer-readable medium for transmitting said output packet to a physical network through said physical input/output adapter of said selected logical partition.

18. The computer program product of claim 15, wherein said assigning instructions further comprise:
instructions on the computer-readable medium for assigning virtual network addresses within a virtual local area network to a plurality of logical partitions residing on multiple processing units within multiple data processing systems.

19. The computer program product of claim 15, wherein said sharing instructions further comprise:
instructions on the computer-readable medium for supporting multiple virtual local area networks with a single physical input/output adapter.

20. The computer program product of claim 15, wherein said assigning instructions further comprise:
instructions on the computer-readable medium for assigning one or more virtual network addresses within a virtual local area network to a plurality of logical partitions residing on multiple processing units on a single data processing system.
